(19) United States
(12) Patent Application Publication
(10) Pub. No.: US 2009/0058084 A1
(43) Pub. Date: Mar. 5, 2009

(54) ADAPTOR FOR QUICK CONNECT COUPLING IN WATER SUPPLY SYSTEM

(76) Inventors: Ronald D. Green, New Hudson, MI (US); Steven J. Tokarz, Canton, MI (US)

Correspondence Address: Masco Corporation, 21001 Van Born Road, Taylor, MI, 48480, US

(21) Appl. No.: 11/850,055

(22) Filed: Sep. 5, 2007

(51) Int. Cl. F16L 35/00

(52) U.S. Cl. 285/328

(57) ABSTRACT

An adaptor is threaded to a threaded nipple on a water shutoff valve in a water supply system. The adaptor has a surface for being captured by a quick connect fluid coupling. The quick connect fluid coupling is in turn connected to a flexible tubing. In this manner, the adaptor can connect the flexible tubing to the threaded surface on the nipple of the shutoff valve, such that the existing shutoff valve design can be utilized with flexible tubing having quick connect fluid couplings.

### BACKGROUND OF THE INVENTION

This application relates to an adaptor which can be utilized to connect a standard threaded connection for a shutoff valve housing to an outlet such as a faucet and allow a quick connect fluid connection to be attached to the valve housing, and communicate with the outlet.

Water supply systems, such as typically utilized in a residence, include a number of outlets such as faucets. A faucet is typically provided with a shutoff valve at the wall. A handle can be turned to shut off a water supply heading to the faucet. As known, a separate shutoff handle is typical provided adjacent the faucet. Historically rigid piping connecting the shutoff valve to the faucet. More recently, flexible tubing, such as plastic tubing has been utilized.

Various connections have been proposed to connect this plastic tubing to the standard threaded connections which are utilized in known shutoff valves. As an example, for remodeling a home, it may sometimes be desirable to connect the existing threaded shutoff valve, which is manufactured for use with rigid pipe, to the new flexible tubing.

It would be desirable to utilize a quick connect fluid coupling, however, the existing shutoff valve would typically have a threaded connection.

### SUMMARY OF THE INVENTION

In a disclosed embodiment of this invention, an adaptor is provided which is connected to the threaded connection on a standard shutoff valve housing. The adaptor has a connection for being connected into a quick connect fluid connection. Now, flexible tubing can be connected to a quick connect connection, and the adaptor can be connected to the shutoff valve housing. In this manner, the flexible tubing can be connected quickly to the adaptor such that a fluid connection between the shutoff valve and the outlet is easily provided.

These and other features of the present invention can be best understood from the following specification and drawings, the following of which is a brief description.

### BRIEF DESCRIPTION OF THE DRAWINGS

FIG. 1 is a first embodiment of the present invention.

FIG. 2 shows a second embodiment of the second embodiment.

FIG. 3A shows a quick connect fluid coupling which may be utilized according to this invention.

FIG. 3B shows one feature of the FIG. 3A quick connect fluid coupling.

### DETAILED DESCRIPTION OF THE PREFERRED EMBODIMENT

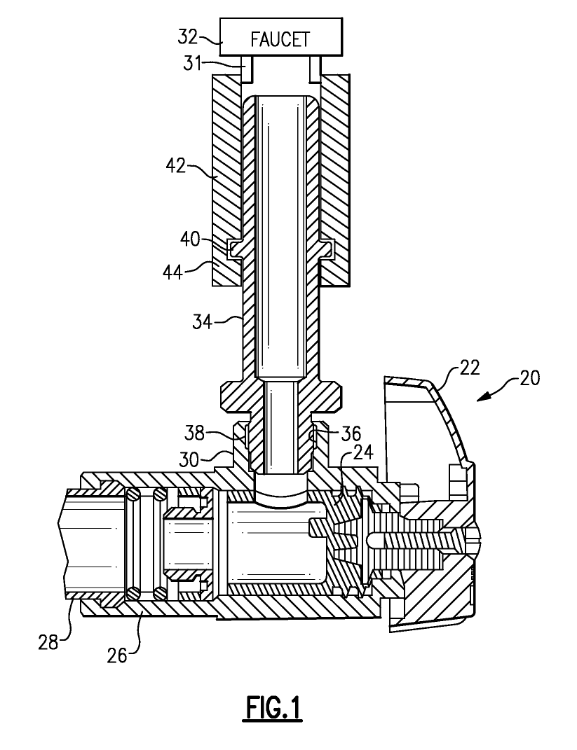

FIG. 1 shows a water supply system 20 including a handle 22 for turning a shutoff valve 24. As is known, the handle 22 is typically mounted in a wall, and communicates an inlet 26 to a water supply 28. Water is supplied from the water supply 28 into the inlet 26, and through the valve 24, into a threaded nipple 30. As shown here, nipple 30 is internally threaded at 36. In this embodiment, an adaptor 34 is threaded at 38. This adaptor allows a quick connect fluid connection 42 to connect a flexible tubing 31 which extends to an outlet such as a faucet 32. The quick connect fluid coupling 42 is shown schematically here.

The adaptor 34 includes an outwardly extending bead 40 which is received beyond snapping fingers 44 on the quick connect fluid coupling 42. The snapping fingers 44 are shown as one example. As is known, a quick connect fluid coupling typically has some moving element which snaps behind a surface, such as bead 40, on a tube or fitting, such as adaptor 34, to quickly secure the adaptor 34 in a fluid tight manner.

With this embodiment, the adaptor 34 can be easily connected to the nipple 30 such that an existing shutoff valve can be easily and quickly connected to a quick connect fluid connection, and the flexible tubing 31. Of course, the adaptor can be utilized with new construction also. The adaptor is well suited for easily allowing the use of the standard threaded nipple, and to connect it to a quick connect fluid coupling.

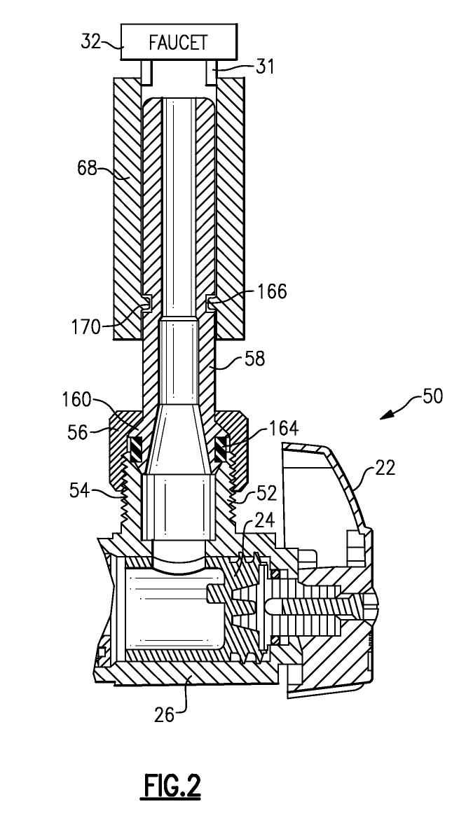

FIG. 2 shows another embodiment, wherein the nipple 52 is externally threaded at 54. A nut 56 catches a forward head 160 of the adaptor 58. A seal ring 164 provides a fluid tight seal. A recess 166 in the adaptor 58 receives a surface 170 from the quick connect fluid coupling. Again, the main function of this invention is to allow a threaded nipple to be connected to a flexible tube through a quick connect fluid coupling.

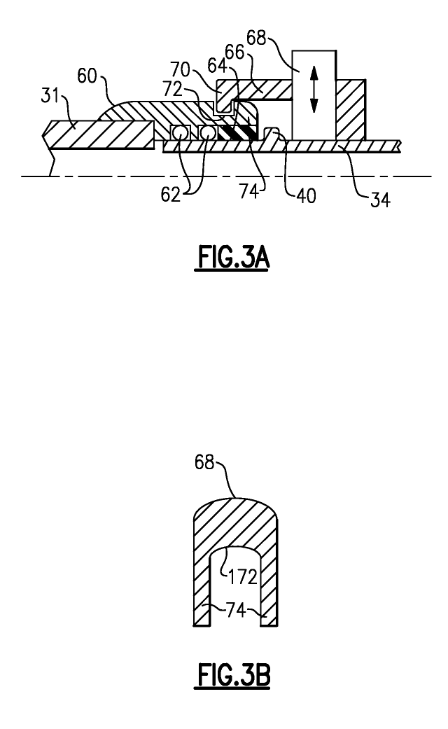

FIG. 3A shows one embodiment quick connect fluid coupling as may be utilized within this invention. As shown, the flexible tubing 31 has an over-molded or spun weld end form. Seals 62 seal on an outer surface of the adaptor 34. Element 64 is a plug to retain seals 62. The example quick connect fluid coupling has a two-part housing, including the over-molded portion 60, and a second snap on portion 66. Snap-on portion 66 includes forward snapping fingers 70 which snap beyond a head 74, and into a groove 72 in the over-molded portion 60.

Since the snap-on portion 66 is formed separately, it can be formed of a flexible material. A retainer 68 has a shape as shown in FIG. 3B, and includes a securing portion 172 and legs 74. The legs 74 move into side slots in the portion 66, and the portion 172 is moved behind the bead 40 to secure the adaptor 34 within the portion 66. Thus, and is generally known in the quick connect art, the retainer 68 is generally moved upwardly as shown in this figure, and the adaptor 34 and its bead 40 can be moved freely into the portion 66. The retainer 68 is then moved downwardly as shown in this figure, and catches the bead 40.

This is but one embodiment in the fluid quick connect fluid coupling within this invention. Any quick connect fluid coupling may be utilized with this invention. More details of other quick connect fluid couplings which may be utilized in this invention are disclosed in co-pending U.S. patent application Ser. No. ______ filed on even date herewith, and naming the inventors of the present application, and entitled “Two-Part Quick Connect Retention Attachment for Flexible Tubing in a Water Supply System.” An appropriate quick connect coupling can also be designed for the FIG. 2 embodiment.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A water supply comprising:
a valve housing having a handle for turning a valve, and allowing or blocking flow of a fluid through the valve housing from a source to an outlet;
a threaded nipple associated with said outlet;
an adaptor associated with a threaded member for securing said adaptor to said nipple; and
a quick connect fluid coupling connecting a flexible tubing to said adaptor, said quick connect fluid coupling having a component which snaps into a position to lock itself to said adaptor.

2. The system as set forth in claim 1, wherein said nipple is internally threaded, and said adaptor has an externally threaded head.

3. The system as set forth in claim 1, wherein said nipple is externally threaded, and said adaptor has an internally threaded component.

4. The system as set forth in claim 3, wherein said internally threaded component is a nut, and said nut captures an end form extending outwardly on said adaptor to secure said adaptor to said nipple.

5. The system as set forth in claim 1, wherein said quick connect fluid coupling connects a flexible tubing to said adaptor.

6. The system as set forth in claim 5, wherein said flexible tubing extends to a faucet.

7. A method of providing a water supply comprising the steps of:
1) attaching an adaptor associated with a threaded member for securing said adapter to a threaded nipple associated with an outlet of a valve housing having a handle for turning a valve, and allowing or blocking flow of a fluid through the valve housing from a source to the outlet;
2) attaching a quick connect fluid coupling to said adaptor, said quick connect fluid coupling having a component which snaps into a position to lock itself to said adaptor, said quick connect fluid coupling connected to a flexible tubing.

8. The method as set forth in claim 7, wherein said nipple is internally threaded, and said adaptor has an externally threaded head.

9. The method as set forth in claim 7, wherein said nipple is externally threaded, and said adaptor has an internally threaded component.

10. The method as set forth in claim 9, wherein said internally threaded component is a nut, and said nut captures an end form extending outwardly on said adaptor to secure said adaptor to said nipple.

11. The method as set forth in claim 7, wherein said quick connect fluid coupling connects a flexible tubing to said adaptor.

12. The method as set forth in claim 11, wherein said flexible tubing extends to a faucet.

13. The method as set forth in claim 7, further including the step of removing an existing threaded connection from said nipple prior to steps 1 and 2.
